(19) United States
(12) Patent Application Publication
(10) Pub. No.: US 2004/0233559 A1
(43) Pub. Date: Nov. 25, 2004

(54) Master carrier for magnetic transfer and magnetic transfer method

(75) Inventor: Masakazu Nishikawa, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/848,408

(22) Filed: May 19, 2004

(30) Foreign Application Priority Data
May 20, 2003 (JP) 142057/2003

(51) Int. Cl. G11B 5/86

(52) U.S. Cl. 360/17

(57) ABSTRACT

Pattern damage caused by defects and the like of a magnetic layer provided on a substrate of a master carrier for magnetic transfer is prevented and durability of the master carrier is improved. The master carrier for magnetic transfer includes a lamination structure, on a substrate, in which not less than one of two-layer structures laminated in a lamination direction, each of the two-layer structures including a magnetic layer and a hard layer having higher hardness than the magnetic layer, which are laminated on each other in an order of the hard layer and the magnetic layer from the substrate side. The master carrier further includes a hard layer which has higher hardness than the magnetic layer on a top surface of the lamination structure.

### BACKGROUND OF THE INVENTION

1. Field of the Invention

The present invention relates to a master carrier for magnetic transfer, which has an uneven pattern corresponding to information to be magnetically transferred to a slave medium, and to a magnetic transfer method using the master carrier.

2. Description of the Related Art

Regarding magnetic recording media, in general, along with increases in the volume of information, large-capacity and inexpensive media which record a lot of information are desired. Moreover, preferably, media which can read necessary parts in a short amount of time, in other words, media capable of so-called high-speed access are desired. As one example of the media described above, there has been known a high density magnetic recording medium which is formed of a hard disk or a flexible disk such as a ZIP drive (Iomega Corp.). The high density magnetic recording medium described above has an information recording area including narrow tracks. In order to accurately scan a narrow track width by use of a magnetic head and to reproduce a signal with high S/N, a so-called tracking servo technology plays a large role.

Servo information such as a servo signal for positioning a track, an address signal of the track and a reproducing clock signal is required to be previously recorded in a magnetic recording medium as a pre-format in manufacturing of the magnetic recording medium. As a method for accurately and efficiently performing this pre-format, a method for magnetically transferring a pattern, which is formed on a master carrier and carries servo information, to a magnetic recording medium has been proposed, for example, in patent document 1 or the like.

In the magnetic transfer, in a state where a master carrier which carries information to be transferred is allowed to be in close contact with a magnetic recording medium (slave medium) such as a magnetic disk medium, a magnetic field for transfer is applied to magnetically transfer a magnetic pattern corresponding to a transfer pattern possessed by the master carrier to the slave medium. Accordingly, the magnetic transfer has the following advantages. Specifically, recording can be statically performed without changing relative positions of the master carrier and the slave medium. In addition, accurate pre-format recording is possible. Moreover, time required for the recording is extremely short.

As the master carrier, the following carriers have been proposed, which include: one including a substrate, in which an uneven pattern corresponding to transfer information is formed, and a magnetic layer provided at least on a convex portion of the substrate; one including a substrate having an uneven pattern formed thereon and a magnetic layer buried in a concave portion of the substrate; and the like.

Since the master carrier is extremely expensive, there has been required development of a master carrier with high durability, which can perform magnetic transfer to more slave media. As a method for improving durability of the master carrier, the following methods have been proposed in patent documents 2 and 3 or the like, which include: a method for providing a DLC film (diamond-like carbon film) on a surface of a magnetic layer of a master carrier; a method for further providing a lubricant layer in a top layer to be a contact surface with a slave medium; and the like.

[Patent Document 1]

U.S. Patent Laid-Open No. 20020075583

[Patent Document 2]

Japanese Unexamined Patent Publication No. 2000-195048

[Patent Document 3]

Japanese Unexamined Patent Publication No. 2001-14665

However, the following fact has become apparent. Specifically, regardless of the fact that a protective layer is provided on a surface of a master carrier and the protective layer remains after the master carrier is used more than once, a pattern of the master is deformed and destroyed. Moreover, transfer failure considered to be caused by this pattern deformation or the like occurs.

Moreover, the following has become apparent from research conducted by the inventors of the present invention. Specifically, when the protective layer formed on the surface is thickened, the pattern deformation is suppressed and the transfer failure caused by the pattern deformation or destruction is reduced. However, the thickness of the protective layer becomes spacing between the master carrier and the slave medium. Thus, a signal quality is lowered.

### SUMMARY OF THE INVENTION

In consideration for the foregoing circumstances, the object of the present invention is to provide a master carrier for magnetic transfer, which can suppress pattern deformation and destruction without lowering a signal quality and has improved durability. The object of the present invention is also to provide a magnetic transfer method using the master carrier.

The master carrier for magnetic transfer according to the present invention is a master carrier for magnetic transfer which includes a substrate having an uneven pattern corresponding to desired information. The master carrier for magnetic transfer includes a lamination structure on the substrate, the lamination structure including not less than one of two-layer structures laminated in a lamination direction. In each of the two-layer structures, a magnetic layer and a hard layer having higher hardness than the magnetic layer are laminated on each other in an order of the hard layer and the magnetic layer from the substrate side. The master carrier for magnetic transfer further includes a hard layer, which has higher hardness than the magnetic layer, on a top surface of the lamination structure.

Each of the hard layers can be formed of any one of, for example: sputtered carbon; diamond-like carbon; and ceramic made of oxide and/or nitride which contain group IIIb or group IVb as a main component. Note that the hardness of the hard layer is preferably not less than 10 GPa, more preferably not less than 15 GPa.

Note that, when the lamination structure includes a plurality of two-layer structures, respective hard layers of the plurality of two-layer structures may have the same hardness or may have different hardness from each other. Moreover, the hard layers of the two-layer structures and the hard layer on the top surface of the lamination structure may have the same hardness or may have different hardness from each other.

Note that the hard layers are made of the same material and formed under the same formation conditions. Thus, the hard layers having the same hardness can be formed. Moreover, by changing the material and/or the formation conditions, the hard layers having different hardness from each other can be formed.

Moreover, assuming that a thickness of the magnetic layer in the two-layer structure is d1 and a thickness of the hard layer therein is d2, it is preferable that a ratio of both the thicknesses d2/d1 is 0.05 to 0.7 (including 0.05 and 0.7, hereinafter the same).

Moreover, it is preferable that a thickness of the hard layer on the top surface is not less than 2 nm but less than 20 nm.

Note that the desired information includes, for example, a servo signal. However, the desired information may include various other data.

A magnetic transfer method of the present invention includes the steps of: applying a magnetic field to a recording medium having a magnetic layer and a master carrier for magnetic transfer of the present invention in a state where a surface of the master carrier and the magnetic layer of the recording medium are in close contact with each other; and transferring information to the recording medium.

The master carrier for magnetic transfer of the present invention includes the two-layer structure formed of the hard layer and the magnetic layer. Thus, even if the hard layer provided on the top surface is thinned, the hardness of the whole layers provided on the substrate can be increased compared to that of the conventional case. In addition, the durability can be improved without lowering the signal quality.

Specifically, the magnetic layer and the hard layer are alternately laminated on each other and the hard layer, which is equivalent to the conventional protective layer, is provided on the top surface. Thus, the hardness of the whole layers on the substrate can be increased. In addition, compared to the conventional case where only one layer of protective layer is provided on the top surface, the entire hardness can be increased while thinning the thickness of the protective layer on the top surface. Thus, a tough and highly durable master carrier can be obtained without lowering the signal quality.

Particularly, when a thickness of the magnetic layer in the two-layer structure is d1 and a thickness of the hard layer therein is d2, a ratio of both the thicknesses d2/d1 is set to 0.05 to 0.7. In such a manner, even if the hard layer is a non-magnetic layer, strong magnetic bond occurs between magnetic layers separated by the non-magnetic layer. Even if the magnetic layers are spatially separated from each other, the magnetic layers can be regarded as magnetically the same. Thus, a highly durable master carrier which does not lower a transfer quality can be obtained.

If the thickness of the hard layer provided on the top surface of the lamination structure is set to not less than 2 nm but less than 20 nm, it is possible to effectively achieve both functions as maintenance of a transfer signal quality and a protective layer. Note that there is a possibility that, if the thickness of this hard layer is less than 2 nm, an effect as the protective layer is lowered and, if the thickness thereof is not less than 20 nm, the transfer signal quality may be lowered.

As described above, by use of the master carrier for magnetic transfer according to the present invention, which has improved durability, a more number of times of magnetic transfer can be performed. As a result, it is possible to suppress manufacturing costs of a magnetic recording medium which has been subjected to magnetic transfer.

According to the magnetic transfer method of the present invention, since the above-described master carrier for magnetic transfer of the present invention is used, transfer to a number of recording media can be performed by use of one master carrier while maintaining a good transfer quality. Thus, recording media with a good transfer quality can be manufactured at low cost.

### BRIEF DESCRIPTION OF THE DRAWINGS

FIG. 1 is a partial perspective view of a surface of a master carrier for magnetic transfer.

FIG. 2 is a cross-sectional view of the master carrier for magnetic transfer shown in FIG. 1.

FIG. 3 is a perspective view showing master carriers and a slave medium.

FIG. 4 is a perspective view schematically showing a configuration of a magnetic transfer device.

FIGS. 5A to 5C are views showing basic steps of a method for magnetic transfer to an in-plane magnetic recording medium.

FIG. 6 is a cross-sectional view of a part of a master carrier for magnetic transfer according to a second embodiment of the present invention.

### DESCRIPTION OF THE PREFERRED EMBODIMENTS

With reference to the drawings, embodiments of the present invention will be described below in detail.

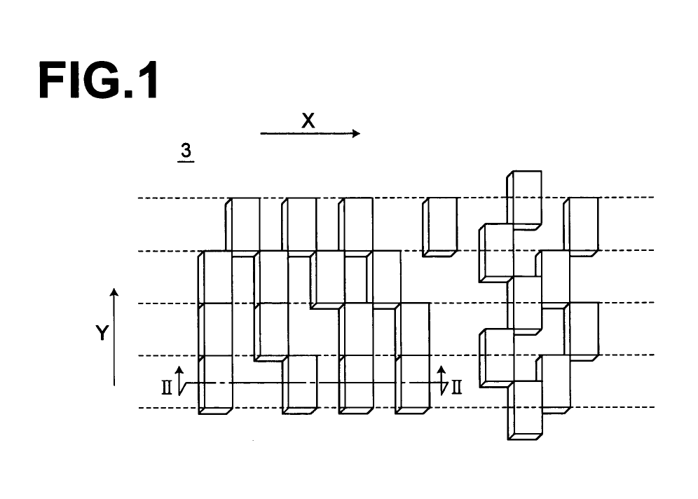

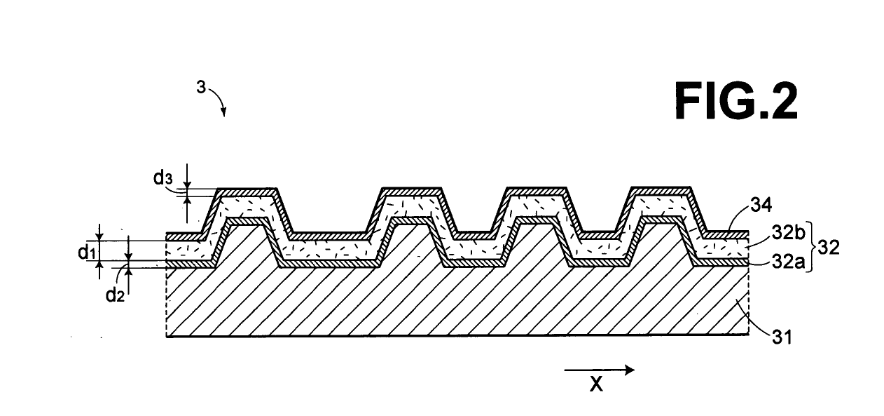

FIG. 1 is a partial perspective view of a surface of a master carrier for magnetic transfer according to this embodiment. FIG. 2 is a cross-sectional view of a part of the master carrier shown in FIG. 1.

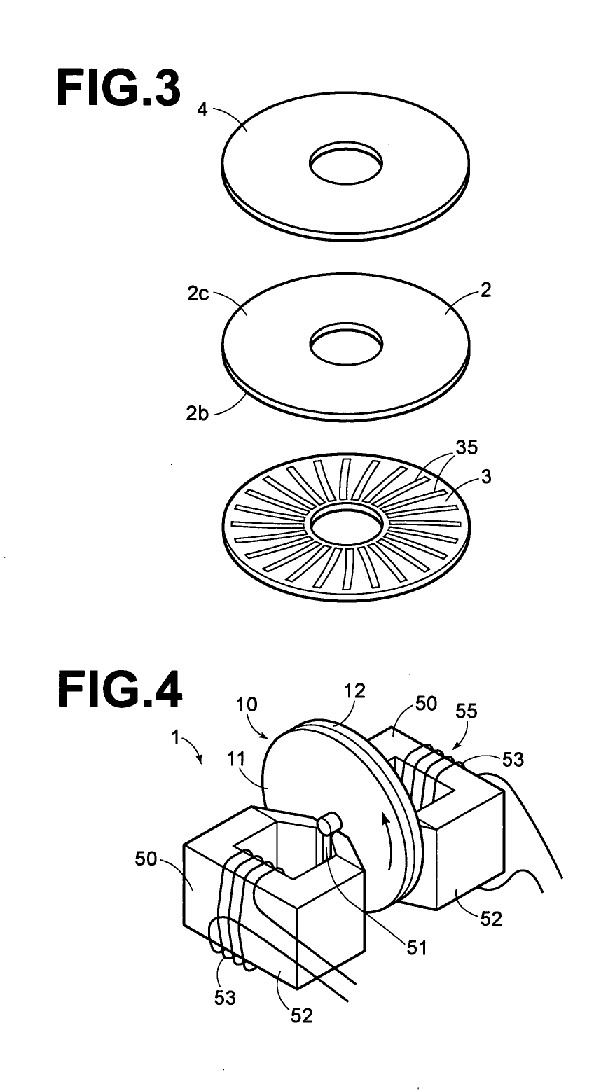

The master carrier 3 of this embodiment is formed in a disk shape as shown in FIG. 3 to be described later. The master carrier 3 has an uneven pattern on its surface as a transfer pattern, the uneven pattern corresponding to information to be transferred to a magnetic recording medium that is a slave medium. The information to be transferred includes, for example, a servo signal. However, the information may include various other data. A partial pattern of the uneven pattern is, for example, one as shown in FIG. 1. In FIG. 1, the arrow X indicates a circumferential direction (track direction) and the arrow Y indicates a radius direction.

FIG. 2 is a II-II cross-sectional view of the master carrier 3 shown in FIG. 1, that is, a cross-sectional view along a vertical plane parallel to the track direction X.

The master carrier 3 includes: a substrate 31 having an uneven pattern on its surface; a two-layer structure 32 laminated on the substrate 31; and a hard layer 34 provided on a top surface of the two-layer structure 32. Note that the hard layer 34 is a layer which has higher hardness than a magnetic layer 32b to be described later and is equivalent to a conventional protective layer. A thickness d3 of this hard layer 34 is set to 2 nm or more and less than 20 nm. This is because, if the thickness d3 is in this range, the hard layer 34 can be allowed to play a role of the protective layer while maintaining a good transfer signal quality.

The two-layer structure 32 includes a hard layer 32a and the magnetic layer 32b which are sequentially laminated in this order from the substrate 31 side. The hard layer 32a is a layer having higher hardness than the magnetic layer 32b. The magnetic layer 32b and the hard layer 32a of the two-layer structure 32 are laminated in such a manner that, when a thickness of the magnetic layer 32b is d1 and a thickness of the hard layer 32a is d2, a ratio of both the thicknesses d2/d1 is 0.05 to 0.7. For example, both the layers are laminated in such a manner that the hard layer 32a has the thickness of 10 nm and the magnetic layer 32b has the thickness of 100 nm, that is, d2/d1=0.1.

As a material of the substrate 31, Ni, Si, a quartz plate, glass, Al, ceramics, synthetic resin or the like is used. Particularly preferable as the substrate material is Ni or ferromagnetic alloy containing Ni as a main component. The substrate 31 having the uneven pattern on its surface can be fabricated by use of a stamper method, a photolithography method or the like.

The method for fabricating the substrate 31 will be outlined. First, photoresist is formed on a glass plate (or a quartz plate) with a smooth surface by use of a spin coat method or the like. Thereafter, while rotating this glass plate, a laser beam (or an electron beam) which is modulated so as to correspond to a servo signal is irradiated. Accordingly, a predetermined pattern is exposed all over the photoresist. For example, a pattern which corresponds to a servo signal extending linearly in a radius direction from the rotation center in each track is exposed to a portion corresponding to each frame on the circumference. Thereafter, the photoresist is subjected to development processing to remove the exposed portion. Thus, a master having an uneven shape formed of the photoresist is obtained. Next, based on the uneven pattern on a surface of the master, this surface is subjected to plating (electroforming). Thus, a Ni substrate having a positive uneven pattern is fabricated and the substrate is peeled off from the master.

Moreover, a substrate having a negative uneven pattern may be fabricated in such a manner that a second master is obtained by plating the master and this second master is plated. Furthermore, a substrate having a positive uneven pattern may be fabricated in such a manner that a third master is obtained by plating the second master or hardening the second master by pressing a resin liquid against the second master and the third master is plated.

As the plating described above, various metal deposition methods are applicable, including electroless plating, electroforming, sputtering and ion plating. A height of a convex portion of the substrate (a depth of the uneven pattern) is preferably in the range of 50 to 800 nm, more preferably in the range of 80 to 600 nm. If this uneven pattern is a sample servo signal, a rectangular convex portion which is longer in the radius direction than in the circumferential direction is formed. Specifically, it is preferable that a length of the convex portion in the radius direction is 0.05 to 20 μm and a length thereof in the circumferential direction is 0.05 to 5 μm. As a pattern carrying information of the servo signal, it is preferable to select values to form a shape longer in the radius direction in this range.

Both of the hard layer 32a in the two-layer structure 32 and the hard layer 34 provided on the top surface of the two-layer structure 32 are layers having higher hardness than the magnetic layer 32b. Specifically, the hard layers described above can be formed of any one of sputtered carbon, diamond-like carbon and ceramic made of oxide and/or nitride which contain group IIIb or group IVb as a main component.

As concrete examples of the ceramic made of oxide and/or nitride which contain group IIIb or group IVb as a main component, SiO, SiO₂, SiN, CN, B, BN, Al₂O₃, AlN and the like are enumerated.

Note that the hardness of the hard layer 34 is preferably 10 GPa or more, more preferably 15 GPa or more.

As a magnetic material of the magnetic layer 32b in the two-layer structure 32, Co, Co alloy (CoNi, CoNiZr, CoNbTaZr and the like), Fe, Fe alloy (FeCo, FeCoNi, FeNiMo, FeAlSi, FeAl and FeTaN), Ni and Ni alloy (NiFe) can be used. FeCo and FeCoNi are particularly preferable. Note that, as the magnetic layer 32b, a magnetic layer having a small coercive force, such as a soft magnetic or semi-hard magnetic layer, is used. Thus, more favorable transfer can be performed. Furthermore, it is preferable that the magnetic layer 32b has a higher saturation magnetization value than that of the substrate 31.

In formation of the two-layer structure 32 on the substrate 31, the magnetic material described above is used. The formation thereof can be performed by use of, for example, vacuum coating means, such as a vacuum deposition method, a sputtering method and an ion plating method, a plating method and the like.

As described above, the master carrier 3 of this embodiment includes the two-layer structure 32 formed of the hard layer 32a and the magnetic layer 32b on the substrate 31. The master carrier 3 further includes the hard layer 34 as the top layer. Thus, the hardness of the whole layers provided on the substrate 31 can be increased. Accordingly, durability of the master carrier can be improved. The improvement in the durability of the master carrier makes it possible to perform magnetic transfer to more slave media. Consequently, a cost reduction effect as a whole can be obtained.

Note that a lubricant layer may be further provided on the hard layer 34. The provision of the lubricant layer makes it possible to suppress occurrence of abrasion caused by friction in correcting misalignment caused in a process of bringing the master carrier into contact with a slave medium. Thus, the durability can be improved more.

Next, description will be given of an embodiment of a magnetic transfer method for transferring information to a slave medium by use of the master carrier for magnetic transfer according to the present invention.

FIG. 3 is a perspective view showing a slave medium 2 and master carriers 3 and 4. The slave medium is, for example, a disc-shaped magnetic recording medium, such as a hard disk and a flexible disk, which has a magnetic recording layer formed on its both sides or one side. Moreover, in this embodiment, the slave medium 2 has recording surfaces 2b and 2c which include in-plane magnetic recording layers 22, respectively, on both sides of a disc-shaped substrate 21.

Moreover, the master carrier 3 is the one described in the foregoing embodiment. As an uneven pattern for the lower recording surface 2b of the slave medium 2, an uneven pattern corresponding to a servo signal is formed in a servo area 35. Moreover, the master carrier 4 includes a layer configuration similar to that of the master carrier 3. On the master carrier 4, an uneven pattern for the upper recording surface 2c of the slave medium 2 is formed.

FIG. 3 shows a state where the magnetic recording medium 2 and the master carriers 3 and 4 are separated from each other. However, actual magnetic transfer is performed in a state where the recording surfaces 2b and 2c of the magnetic recording medium 2 and transfer pattern surfaces of the master carriers 3 and 4 are allowed to be in close contact with each other.

FIG. 4 is a perspective view schematically showing a configuration of a magnetic transfer device for performing the magnetic transfer by use of the master carrier for magnetic transfer according to the present invention. The magnetic transfer device 1 includes contact pressure application means and magnetic field application means 55 for applying a transfer magnetic field while rotating the transfer holder 10. Specifically, the contact pressure application means includes: a transfer holder 10 which holds the master carriers 3 and 4 and the slave medium 2 by allowing the master carriers 3 and 4 and the slave medium 2 to be in close contact with each other; and unillustrated vacuum suction means for obtaining contact force by performing vacuum suction of air in an internal space of the transfer holder 10 and allowing inside of the transfer holder 10 to be in a reduced-pressure state.

The magnetic field application means 55 is configured as follows. The magnetic field application means 55 includes electromagnet devices 50 and 50 provided at both sides of the transfer holder 10. Coils 53 are entwined around cores 52 of the electromagnet devices 50 and 50, the cores having gaps 51 extending in a radius direction of the transfer holder 10. Both the electromagnet devices 50 and 50 generate a magnetic field in a direction parallel to and the same as the track direction. Moreover, the magnetic field application means 55 may include permanent magnet devices instead of the electromagnet devices. In the case of perpendicular recording, the magnetic field application means can include electromagnets or permanent magnets which are provided at both sides of the transfer holder 10 and have different polarities from each other. Specifically, in the case of the perpendicular recording, a transfer magnetic field is generated in a direction perpendicular to a track surface.

Moreover, the magnetic field application means 55 is configured as follows. The electromagnet devices 50 and 50 at both sides of the transfer holder 10 contact or separate from each other so that an opening/closing operation of the transfer holder 10 is allowed. Alternatively, the electromagnet devices 50 and 50 or the transfer holder 10 move so that the transfer holder 10 is inserted between the electromagnet devices 50 and 50.

The transfer holder 10 includes one side holder 11 at the left side and the other side holder 12 at the right side, which can be relatively moved to contact or separate from each other. The transfer holder 10 houses the slave medium 2 and the master carrier 3 in the internal space formed between both the holders 11 and 12. The slave medium 2 and the master carrier 3 are attached to each other, by pressure reduction in the internal space, so as to be in close contact with each other in a state where center positions thereof are aligned with each other.

On a pressing surface of the one side holder 11, the one master carrier 3, which transfers information of the servo signal and the like to one side of the slave medium 2, and the slave medium 2 are held by suction or the like. On a pressing surface of the other side holder 12, the other master carrier 4 which transfers information of the servo signal and the like to the other side of the slave medium 2 is held by suction or the like.

At center positions on back faces of the one side holder 11 and the other side holder 12, supporting shafts are provided in an extended condition, respectively. The supporting shafts are supported by a device main body and connected with a rotating mechanism. The supporting shafts are rotationally driven in the magnetic transfer.

Moreover, the pressure in the internal space of the transfer holder 10 is reduced to a predetermined degree of vacuum when the slave medium 2 and the master carriers 3 and 4 are in close contact with each other. Thus, contact force between the slave medium 2 and the master carriers 3 and 4 is obtained. In addition, contact property is improved by evacuating air from a contact surface. Moreover, in air releasing and peeling, compressed air is introduced to the internal space. Furthermore, in order to apply the contact force, the transfer holder may be mechanically pressurized from the outside in addition to the vacuum suction.

Next, description will be given of a magnetic transfer method by use of the magnetic transfer device 1 described above. The transfer holder 10 of the magnetic transfer device described above performs magnetic transfer to a plurality of slave media 2 by use of a pair of master carriers 3 and 4. First, the master carriers 3 and 4 are aligned with each other and held by the one side holder 11 and the other side holder 12. Subsequently, in an opened state where the one side holder 11 and the other side holder 12 are separated from each other, the slave medium 2 is set while aligning its center position with those of the master carriers, the slave medium 2 being previously subjected to initial magnetization in one of an in-plane direction and a perpendicular direction. Thereafter, the other side holder 12 and the one side holder 11 are moved to come close to each other, which results in a closed state. The internal space of the transfer holder 10, which houses the slave medium 2 and the master carriers 3 and 4, is subjected to vacuum suction to reduce a pressure therein. Accordingly, contact force is evenly applied to the slave medium 2 and the master carriers 3 and 4. Thus, the slave medium 2 and the master carriers 3 and 4 are allowed to be in close contact with each other. For the application of the contact force, the transfer holder may be mechanically pressurized from the outside in addition to the vacuum suction.

Thereafter, the electromagnet devices 50 and 50 are allowed to come close to both sides of the transfer holder 10. While rotating the transfer holder 10, a transfer magnetic field is applied in a direction approximately opposite to that of the initial magnetization by the electromagnet devices 50 and 50. Subsequently, magnetization patterns corresponding to transfer patterns of the master carriers 3 and 4 are transferred and recorded in a magnetic recording layer of the slave medium 2.

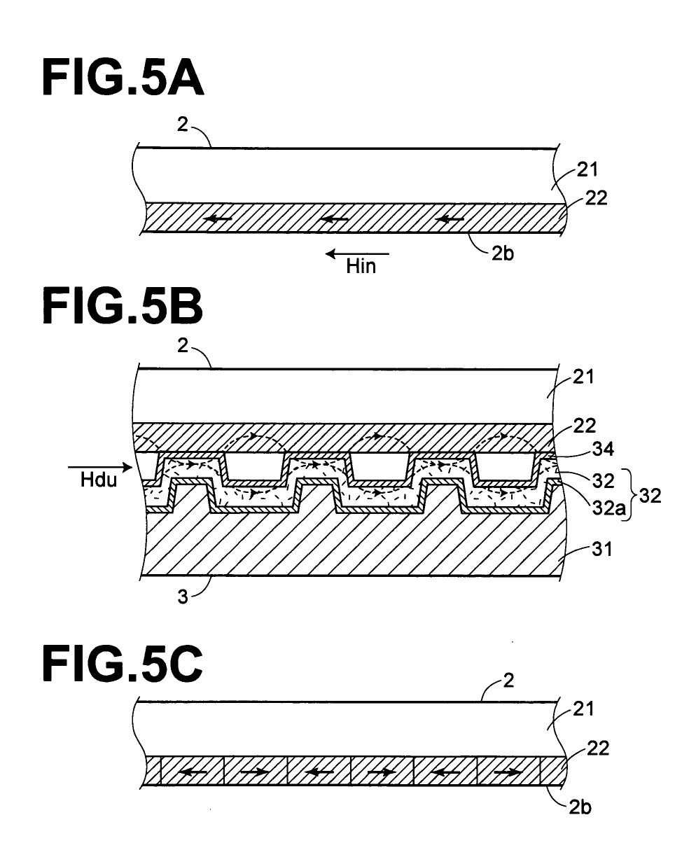

FIGS. 5A to 5C are views for explaining basic steps of magnetic transfer to an in-plane magnetic recording medium. FIG. 5A shows a step of subjecting a slave medium to initial DC magnetization by applying a magnetic field in one direction. FIG. 5B shows a step of applying a magnetic field in a direction approximately opposite to that of the initial DC magnetization while allowing a master carrier and the slave medium to be in close contact with each other. FIG. 5C shows a state of a recording surface of the slave medium after magnetic transfer. Note that FIGS. 5A to 5C show only the lower recording surface 2b side of the slave medium 2.

As shown in FIG. 5A, a unidirectional initial DC magnetic field Hin in the track direction is previously applied to the slave medium 2. Thus, a magnetic recording layer 22 is previously subjected to the initial DC magnetization. Thereafter, as shown in FIG. 5B, the recording surface 2b of the slave medium 2 and a transfer pattern surface of the master carrier 3 are allowed to be in close contact with each other. Accordingly, a transfer magnetic field Hdu in a direction opposite to that of the initial DC magnetic field Hin is applied in the track direction of the slave medium 2. In spots where the slave medium 2 and the transfer pattern of the master carrier 3 are in close contact with each other, the transfer magnetic field Hdu is sucked into convex portions of the master carrier 3. The magnetization of the slave medium 2, which corresponds to those portions, is not reversed and the initial magnetization in other portions is reversed. As a result, as shown in FIG. 5C, in the magnetic recording layer 22 of the lower recording surface 2b of the slave medium 2, information corresponding to the uneven pattern of the master carrier 3 (for example, a servo signal) is magnetically transferred and recorded. Here, the description was given of the magnetic transfer to the lower recording surface 2b of the slave medium 2 by use of the lower master carrier 3. However, the magnetic transfer is similarly performed for the upper recording surface 2c of the magnetic recording medium 2 by allowing the upper recording surface to be in close contact with the upper master carrier 4. Note that the magnetic transfer to the upper and lower recording surfaces 2b and 2c of the magnetic recording medium 2 may be performed simultaneously or sequentially one surface at a time.

Note that, for the initial DC magnetic field and the transfer magnetic field, it is required to adopt values which are determined by taking into consideration coercive force of the slave medium, relative permeability of the master carrier and the slave medium and the like.

The basic steps of the magnetic transfer described in FIGS. 5A to 5C are those in the case where the slave medium is the in-plane recording medium. If the slave medium is a perpendicular recording medium, the direction of the initial magnetization and the direction of applying the transfer magnetic field may be set perpendicular to the surface of the recording medium. Note that, in the case of perpendicular recording, the initial magnetization in portions which are in close contact with the convex portions of the master carrier is reversed and the initial magnetization in other portions is not reversed. As a result, a magnetization pattern corresponding to the uneven pattern is transferred.

As the slave medium 2, a disc-shaped magnetic recording medium which includes a coating type magnetic recording layer or a metal thin film type magnetic recording layer, such as a hard disk and a high-density flexible disk, can be used.

Note that, in the case of the magnetic recording medium including the metal thin film type magnetic recording layer, Co, Co alloy (CoPtCr, CoCr, CoPtCrTa, CoPtCrNbTa, CoCrB, CoNi, Co/Pd and the like), Fe and Fe alloy (FeCo, FePt and FeCoNi) can be used as a magnetic material. In order to perform clear transfer, it is preferable that the magnetic recording layer (magnetic layer) has large magnetic flux density and magnetic anisotropy in an in-plane direction in the case of in-plane recording or in a perpendicular direction in the case of perpendicular recording. A thickness of the magnetic layer is preferably 10 to 500 nm, more preferably 20 to 200 nm.

Moreover, it is preferable that a non-magnetic base layer is provided below the magnetic layer (the substrate side) in order for the magnetic layer to have necessary magnetic anisotropy. As the base layer, Cr, CrTi, CoCr, CrTa, CrMo, NiAl, Ru, Pd or the like can be used. However, it is required to select one having a crystal structure and a lattice constant which coincide with those of the magnetic layer provided thereabove. A thickness of the non-magnetic layer is preferably 10 to 150 nm, more preferably 20 to 80 nm.

Furthermore, in the case of a perpendicular magnetic recording medium, a soft magnetic backing layer may be provided below the non-magnetic base layer, in order to stabilize a perpendicular magnetization state of the magnetic layer and improve sensitivity in recording and reproduction. As the backing layer, NiFe, CoCr, FeTaC, FeAlSi or the like can be used. A thickness of the backing layer is preferably 50 to 2000 nm, more preferably 60 to 400 nm.

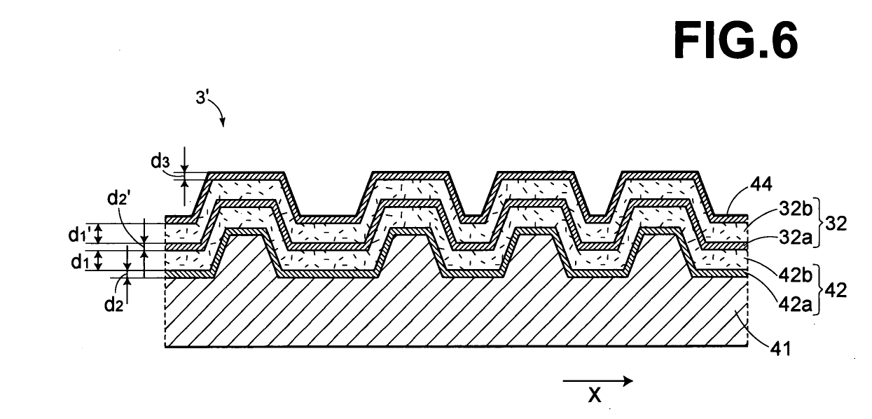

FIG. 6 shows a cross-sectional view of a portion of a master carrier according to a second embodiment of the present invention.

The master carrier 3′ includes: a substrate 41 having an uneven pattern on its surface; a lamination structure including two two-layer structures 42 and 43 laminated on the substrate 41; and a hard layer 44 provided on a top surface of the lamination structure. Moreover, the two-layer structures 42 and 43 include hard layers 42a and 43a and magnetic layers 42b and 43b, which are sequentially laminated from the substrate 41 side. The magnetic layer 42b and the hard layer 42a of the two-layer structure 42 are laminated in such a manner that, when a thickness of the magnetic layer 42b is d1 and a thickness of the hard layer 42a is d2, a ratio of both the thicknesses d2/d1 is 0.05 to 0.7. The magnetic layer 43b and the hard layer 43a of the two-layer structure 43 are laminated in such a manner that a ratio of a thickness d1′ of the magnetic layer 43b and a thickness d2′ of the hard layer 43a has a similar relationship to that described above. However, the thickness ratios of the magnetic layers and the hard layers in the respective two-layer structures 42 and 43 are not required to be the same but may be different from each other within the range of 0.05 to 0.7. The respective hard layers 42a and 43a of the two-layer structures 42 and 43 may have the same hardness or different hardness from each other. Even if the hard layers are made of the same material, the hardness can be changed by changing deposition conditions such as sputtering conditions. Moreover, the hardness can be also changed by, for example, adding dopant to a main raw material. The respective magnetic layers 42b and 43b of the two-layer structures 42 and 43 may be magnetic layers having the same composition or different compositions from each other.

Also in this embodiment, a thickness d3 of the hard layer 44 to be the top layer is set to 2 nm or more and less than 20 nm.

Note that the master carrier of this embodiment includes the lamination structure in which two of the two-layer structures are laminated in a lamination direction. However, three or more of the two-layer structures may be laminated. As described above, the lamination of a plurality of the two-layer structures makes it possible to further increase strength of the whole layers on the substrate. In addition, durability of the master carrier can be improved.

### [EXAMPLES]

Next, description will be given of results obtained by fabricating and evaluating master carriers for magnetic transfer of examples and comparative examples according to the present invention.

First, respective master carriers will be described.

A master carrier of a magnetic transfer device of example 1 included a disc-shaped Ni substrate, which was fabricated by use of a stamper method, as a substrate. On the Ni substrate, an uneven pattern signal was formed, which had, within 20 to 40 mm in a radius direction from the center of the disc, a track width of 0.3 μm, a track pitch of 0.32 μm, a bit length of 0.15 μm at a position of 20 mm in the radius direction, that was the innermost circumference, and a convex portion height (concave portion groove depth) of 0.1 μm.

On the substrate, a two-layer structure was formed, in which a hard layer with a thickness of 10 nm (=d2) which was made of diamond-like carbon (DLC) having hardness of 20 GPa and a magnetic layer with a thickness of 100 nm (=d1) which was made of FeCo 30 at % were laminated in this order from the substrate side. Furthermore, a hard layer with a thickness of 10 nm, which was made of DLC, was laminated on a top surface of the two-layer structure. Thus, the master carrier was obtained. Specifically, a thickness ratio d2/d1 of the magnetic layer and the hard layer of the master carrier of this example 1 was 0.1. Both of the hard layer and the magnetic layer were sequentially formed at a substrate temperature of 25° C. by use of a vacuum evaporator (Shibaura Mechatronics: Octava sputtering system). The magnetic layer was formed under conditions of Ar sputtering pressure 1.5×10-1 Pa (1.08 mTorr) and applied power 2.80 W/cm² in a state where a pressure of the atmosphere is reduced to 1.33×10-5 Pa (10-7 Torr).

As a slave medium, a 3.5-inch disc-shaped magnetic recording medium was used, which included a magnetic layer having saturation magnetization Mc: 5.7 T (4500 Gauss) and coercive force Hc: 199 kA/m (25000e) on an Al substrate.

In example 2, used was a master carrier for magnetic transfer which was similar to that of example 1 except that two of two-layer structures were laminated in a lamination direction, each of the two-layer structures including DLC with a thickness of 10 nm and FeCo 30 at % with a thickness of 100 nm.

In example 3, used was a master carrier for magnetic transfer which was similar to that of example 1 except that five of two-layer structures were laminated in a lamination direction, each of the two-layer structures including DLC with a thickness of 10 nm and FeCo 30 at % with a thickness of 100 nm.

In example 4, used was a master carrier for magnetic transfer which was similar to that of example 1 except that hardness of DLC was set to 9 GPa.

In example 5, used was a master carrier for magnetic transfer which was similar to that of example 1 except that the hard layer had the thickness d2 of 0.1 nm and the thickness ratio was set to d2/d1=0.001.

In example 6, used was a master carrier for magnetic transfer which was similar to that of example 1 except that the hard layer had the thickness d2 of 80 nm and the thickness ratio was set to d2/d1=0.8.

In comparative example 1, used was a master carrier for magnetic transfer which was similar to that of example 1 except that the master carrier included no two-layer structure, a magnetic layer with a thickness of 100 nm which was made of FeCo 30 at % was laminated directly on a substrate and a hard layer made of DLC with a thickness of 10 nm was laminated on the magnetic layer.

In comparative example 2, used was a master carrier for magnetic transfer which was similar to that of comparative example 1 except that DLC on a top surface had a thickness of 20 nm.

In comparative example 3, used was a master carrier for magnetic transfer which was similar to that of example 1 except that Cu having hardness of 6 GPa was used in place of the hard layer in the two-layer structure and the hard layer disposed on the top surface.

By use of the master carriers for magnetic transfer of examples 1 to 6 and comparative examples 1 to 3, magnetic transfer was performed for 10000 slave media, respectively. Accordingly, the following measurements and evaluations were performed. Note that contact pressure of the master carrier and the slave medium in the magnetic transfer was 0.4 MPa (4.0 kgf/cm²).

<Method for measuring and evaluating spots of transfer failure>

Spots of transfer failure caused by damage of a pattern of a master carrier were measured.

By use of a telecentric device, defective spots over the entire surfaces of the 1^{st}, 10^{th}, 100^{th}, 1000^{th} and 10000^{th} slave media and the master carrier at each time of close contact were detected at 3-fold magnification. Note that, for the slave media, spots of transfer failure were further detected from a reproducing signal of a transferred magnetization pattern. Specifically, in the slave media, defects in terms of shape and defects due to transfer failure were both regarded as defects in the slave media.

The defective spots on the master carrier and the defective spots on the slave media were compared. Accordingly, the defective spots which match were regarded as defects caused by the pattern damage of the master carrier. Evaluations were made in the following manner: good (◯) if the number of defects caused by the pattern damage is less than 5; acceptable (Δ) if the number thereof is 5 to 9; and poor (X) if the number thereof is 10 or more. Note that the evaluation was made as poor if the slave medium having 10 or more of defective spots is found even once before the 10000^{th} slave medium.

<Method for evaluating signal quality>

By use of an electromagnetic conversion characteristic measuring instrument (SS-60 manufactured by Kyodo Denshi System Co., Ltd.), a transfer signal of a slave medium was evaluated. As a head, used was a GMR head having a reproducing head gap of 0.12 μm, a reproducing track width of 0.6 μm, a recording head gap of 0.18 μm and a recording track width of 0.75 μm. For the first slave medium, measured was a difference (C/N) of medium noise (N) obtained by subjecting a read signal to frequency analysis by use of a spectroanalyzer and performing extrapolation with peak strength (C) of a primary signal. Assuming that a C/N value of example 1 is 0 dB, relative values Δ C/N to the C/N value of example 1 were obtained and evaluated for the respective examples and comparative examples. Accordingly, evaluations were made in the following manner: good (◯) if Δ C/N is less than −2.0 dB; acceptable (Δ) if Δ C/N is −2.0 to −3.0 dB; and poor (X) if Δ C/N is greater than −3.0 dB.

Table 1 shows results of measurements and evaluations.

TABLE 1

| | | | HARDNESS | | NUMBER OF SLAVES/ | | | | | | | |
|---|---|---|---|---|---|---|---|---|---|---|---|---|
| | NUMBER OF | | OF | | NUMBER OF SPOTS OF | | | | | | | |
| | TWO-LAYER | HARD | HARD LAYER | | TRANSFER FAILURE | | | | | EVALU- | ΔC/N | EVALU- |
| | STRUCTURES | LAYER | (GPa) | d2/d1 | 1 | 10 | 100 | 1000 | 10000 | ATION | (dB) | ATION |
| EXAMPLE 1 | 1 | DLC | 20 | 0.1 | 2 | 1 | 2 | 1 | 2 | ◯ | 0 | ◯ |
| EXAMPLE 2 | 2 | DLC | 20 | 0.1 | 1 | 0 | 0 | 1 | 1 | ◯ | −0.8 | ◯ |
| EXAMPLE 3 | 5 | DLC | 20 | 0.1 | 0 | 0 | 1 | 0 | 0 | ◯ | −0.7 | ◯ |
| EXAMPLE 4 | 1 | DLC | 9 | 0.1 | 1 | 0 | 2 | 1 | 5 | Δ | −0.2 | ◯ |
| EXAMPLE 5 | 1 | DLC | 20 | 0.001 | 1 | 0 | 2 | 2 | 7 | Δ | 0 | ◯ |
| EXAMPLE 6 | 1 | DLC | 20 | 0.8 | 0 | 1 | 3 | 2 | 2 | ◯ | −2.2 | Δ |
| COMPARATIVE EXAMPLE 1 | 0 | — | — | — | 0 | 2 | 0 | 3 | 12 | X | −0.1 | ◯ |
| COMPARATIVE EXAMPLE 2 | 0 | — | — | — | 0 | 1 | 2 | 4 | 4 | ◯ | −3.4 | X |
| COMPARATIVE EXAMPLE 3 | 1 | Cu | 6 | 0.1 | 3 | 7 | 15 | 30 | 92 | X | −0.1 | ◯ |

As shown in Table 1, in examples 1 to 6 of the present invention, results equivalent to “acceptable” or more were obtained for both of the number of defects caused by the pattern damage and the signal quality. Particularly, in examples 1 to 3 in which the hardness of the hard layer was high and the thickness ratio d2/d1 of the magnetic layer and the hard layer was within a preferable range (0.05 to 0.7), good results were obtained for both of the number of defects caused by the pattern damage and the signal quality. Meanwhile, in comparative examples 1 to 3, at least any one of the number of defects caused by the pattern damage and the signal quality was evaluated as poor. In comparative example 1 that was a conventional master carrier, a result that a conventional signal quality is sufficiently good was obtained. However, compared to examples 1 to 6, it is clear that durability is low and pattern damage occurs along with an increase in the number of times of transfer. Moreover, in comparative example 2, the following result was obtained. Specifically, since a thickness of a hard layer, that was a protective layer in the conventional master carrier, was as thick as 20 nm, durability was high. Thus, the pattern damage was small even if transfer is performed over and over. However, a conventional transfer signal quality was low.

What is claimed is:

1. A master carrier for magnetic transfer, which includes a substrate having an uneven pattern corresponding to information, comprising:
a lamination structure, on the substrate, in which not less than one of two-layer structures are laminated in a lamination direction, each of the two-layer structures including a magnetic layer and a hard layer having higher hardness than the magnetic layer, which are laminated on each other in an order of the hard layer and the magnetic layer from the substrate side; and
a hard layer, which has higher hardness than the magnetic layer, on a top surface of the lamination structure.

2. The master carrier for magnetic transfer according to claim 1, wherein each of the hard layers is formed of any one of sputtered carbon, diamond-like carbon and ceramic made of oxide and/or nitride which contain group IIIb or group IVb as a main component.

3. The master carrier for magnetic transfer according to claim 1, wherein the lamination structure includes a plurality of the two-layer structures and respective hard layers of the plurality of two-layer structures have different hardness from each other.

4. The master carrier for magnetic transfer according to claim 1, wherein, when a thickness of the magnetic layer in the two-layer structure is d1 and a thickness of the hard layer therein is d2, a ratio of both the thicknesses d2/d1 is 0.05 to 0.7.

5. The master carrier for magnetic transfer according to claim 1, wherein a thickness of a hard layer on the top surface is not less than 2 nm but less than 20 nm.

6. The master carrier for magnetic transfer according to claim 1, wherein said substrate comprises Ni or a Ni alloy.

7. The master carrier for magnetic transfer according to claim 1, wherein protrusion portions of said uneven pattern have heights in a range from 50 to 800 nm.

8. The master carrier for magnetic transfer according to claim 1, wherein said magnetic layer comprises Co, a Co alloy, Fe, a Fe alloy, Ni, or a Ni alloy.

9. A process of producing a magnetic recording medium having data recorded thereon, comprising the steps of:
preparing a magnetic transfer master carrier comprising a non-magnetic substrate, which has a surface with protrusion portions and depression portions corresponding to said data;
preparing a slave medium comprising a non-magnetic support, which has a magnetic recording layer thereon;
bringing said surface of the master carrier into intimate contact with said magnetic recording layer of said slave medium to form a conjoined body; and
applying a transfer magnetic field to said conjoinedbody, thereby obtaining said magnetic recording medium having said data recorded thereon; wherein
said master carrier comprises at least one lamination structure, said lamination structure comprising a two layer structure that includes a first non-magnetic layer and a magnetic layer in this order, on said surface with the protrusion portions and the depression portions, and a second non-magnetic layer on the top surface of said lamination structure; and
said first and second non-magnetic layers each have a higher degree of hardness than said magnetic layer.

10. The process as defined in claim 9, wherein each of the hard layers is formed of any one of sputtered carbon, diamond-like carbon and ceramic made of oxide and/or nitride which contain group IIIb or group IVb as a main component.

11. The process as defined in claim 9, wherein the lamination structure includes a plurality of the two-layer structures and respective hard layers of the plurality of two-layer structures have different hardness from each other.

12. The process as defined in claim 9, wherein, when a thickness of the magnetic layer in the two-layer structure is d1 and a thickness of the hard layer therein is d2, a ratio of both the thicknesses d2/d1 is 0.05 to 0.7.

13. The process as defined in claim 9, wherein a thickness of a hard layer on the top surface is not less than 2 nm but less than 20 nm.

14. The process as defined in claim 9, wherein said substrate comprises Ni or a Ni alloy.

15. The process as defined in claim 9, wherein protrusion portions of said uneven pattern have heights in a range from 50 to 800 nm.

16. The process as defined in claim 9, wherein said magnetic layer comprises Co, a Co alloy, Fe, a Fe alloy, Ni, or a Ni alloy.

17. The process as defined in claim 9, wherein said slave medium comprises a thin metallic magnetic film comprising Co, a Co alloy, Fe, or a Fe alloy.

18. The process as defined in claim 17, wherein said slave medium further comprises a non-magnetic sub-layer comprising Cr, CrTi, CoCr, CrTa, CrMo, NiAl, Ru, or Pd, under said thin metallic magnetic film.
